(19) United States
(12) Patent Application Publication
(10) Pub. No.: US 2007/0250445 A1
(43) Pub. Date: Oct. 25, 2007

(54) REAL TIME, ON THE FLY, DISTRIBUTION OF PRE-SELECTED ELECTRONIC CONTENT

(75) Inventor: Marc Ache, Long Island City, NY (US)

Correspondence Address: DARBY & DARBY P.C., P.O. BOX 770, Church Street Station, New York, NY, 10008-0770, US

(73) Assignee: Napster LLC, New York, NY (US)

(21) Appl. No.: 11/379,277

(22) Filed: Apr. 19, 2006

(51) Int. Cl. H04L 9/00

(52) U.S. Cl. 705/51

(57) ABSTRACT

A system and method of refreshing a user's pre-selected content automatically every time a playback device is connected to a provider system. The user selects what order and time the electronic content is provided and played back and electronic content to be “broken in” during a differently scheduled set of electronic content. The system can track which playback device is in use and provide “handoff” features between devices. The system allows a user to identify temporary playback devices. Another embodiment automatically generates playlists or schedules based on the user's previous selections. The system analyses the amount of unused memory on the user device and generates a playlist to fill any or all available memory on the user device. Also, if the user links the user's organizer, the system alters the user's schedule or customizes the automatically generated schedule to the user's date book.

### FIELD OF THE INVENTION

The present invention relates to the real time, on the fly distribution of electronic content over a LAN or wireless LAN.

### BACKGROUND OF THE INVENTION

A typical digital rights management (DRM) system uses tokens to protect distributed electronic content. The token contains information pertaining at least to all of the rights a user is allowed to exercise with the content. Typically a new token is generated for each new right a user wants. For example, if a user wants to stream content, a “streaming” token is generated. If a user then wants to bum the content, a “burning” token is generated. New DRM systems are available that generate a “master token” and allow the electronic content to be distributed among multiple devices without generating a new token (e.g. Microsoft™ Janus™). Electronic content can be tracked and distributed to any or all of a user's playback devices with ease. The new “master token” systems configure hardware and software protocols to allow electronic playback devices to communicate and to assure the security of the electronic content as it is passed between playback devices. Additionally, a number of on-line providers of electronic content are currently available utilizing a various array of DRM systems. Most DRM systems allow for content to be provided as below.

A user subscribes to a provider's service (e.g. Napster™) and is allowed access to electronic content. A user typically has a number of options to listen to or view the electronic content. One option is to pay an additional fee and download a copy of the electronic content for his or her unlimited use. Unlimited use is use without constraints, for example, access to the electronic content does not expire once the user's membership expires and does not end once the network connection to the provider ends. Unlimited use includes moving the electronic content to a different computer or a MP3 player or making a copy (“burning”) on to any permanent or semi-permanent media (e.g. CD, DVD, VHS, and DAT).

Another option, as part of a subscription fee or a pay-per-view fee, a user can “stream” electronic content. The electronic content can either be previously recorded or performed in real time while the user is networked to the provider. The user has to actively choose the electronic content he wants streamed. The electronic content is streamed, but never updated. Further, the electronic content is not stored on the user's computer or other electronic device. The electronic content may be temporally stored to allow seamless playback but then deleted once the streaming session is complete.

A third option is that content is downloaded to the user's computer or electronic device and can be played back when the user is not networked to the provider's service. The user can only play back the electronic content and is prohibited from performing any other action with electronic content. The electronic content is protected such that it cannot be copied or moved, and the user's access to the content expires once the user account with the provider is terminated by cancellation or expiration.

In all of the above methods to access electronic content, all of the content must be selected by the user at the time the user wants to produce the content and the content is “pulled” down by the user either on to a single electronic device recording media.

Another type of “pulled” content is beginning to be known as “podcasting” wherein users create a combination of different content (e.g. multiple songs—similar to a playlist; talk; and other content) and another user can download the combination to a portable device and playback the electronic content at any time. Once the content is downloaded the device does not need to be networked to replay the content. However, a user must select the content and actively “pull” the content down. Once the content is down, it is not refreshed until the user downloads the update. Thus, the content is “stale” or old once it is downloaded since updates and newer content can be created once the user makes the download and those updates are not transmitted to the user unless the user actively downloads them.

Alternately, users are familiar with television and radio. The content provided by television and radio is broadcast or “pushed” to the user in that the user only needs to turn on his TV or radio and content is provided. The content on both radio and television is continually updated and delivered in real time. A user can select a station and expect a certain type of content to be broadcast on each station. However, a user cannot pick and choose the content broadcast on each station and must select between multiple stations to have all the content the user wants performed. Additionally, the user is constrained to the broadcast schedule set by the provider and cannot time shift the content to be broadcast at a different time.

Additionally, a user cannot determine in what order the broadcast content is provided, it is broadcast as the provider chooses. The user can record the broadcast and then alter the order as he desires but this is a manual process that must be performed by the user each time the broadcasts are recorded.

Third party services, who are not electronic content providers, offer some functionality that bridges the gap between selecting the electronic content by the user and content that is broadcast. For example, some digital video recorders (DVRs) (e.g. TiVo™) provide services that allow a user to select the exact content (i.e. television series) to record every time it is broadcast (e.g. TiVo™ Season Pass™) or select a topic (e.g. a particular actor, sport, or genera—TiVo™ Wish List™) to display and record. However, since the content is recorded, the user still must “pull” the content off the recorder, it is not automatically provided to the user. Additionally, the content is exclusively stored on the DVR which does not communicate with other electronic playback devices and is fixed in one location. Thus, it is not synchronized across all of the user's devices for playback and the user is confined to one location to produce the electronic content.

It is a goal of the present invention to allow selected content to be broadcast to all of a user's electronic devices. Further, the content can be continually updated whenever the user's device is networked.

### SUMMARY OF THE INVENTION

The present invention allows a user to have pre-selected content refreshed automatically every time the playback device is connected to a provider system that makes available to a user multiple types of electronic content. Electronic content can be audio, video, still images, data, software, text or a combination of any or all types. The electronic content can be divided into categories or stations based on a common theme. Some generic examples are “easy listening” audio content, western video content, sports, or audio or video from a particular radio disk jockey, news reporter, movie director, artist, or actor.

The user typically connects to the provider system over a network which can be a wired or wireless LAN (local area network), WAN (wide area network), cellular/telephone network or the Internet. The user also has one or more devices to playback the electronic content which can be an MP3 player, a cellular telephone/pager/Blackberry, a stereo/DVR, a car mounted audio/video system and at least a computer/laptop/PDA.

The user can access an account with provider system, provides the required information regarding his playback devices and selects one or more stations of electronic content. Once the user has selected the station and/or electronic content, the user can be prompted as to which playback device should be linked to each station. Once the stations and playback devices are configured, provider system continuously updates playback devices every time playback devices are networked to the provider system. Provider system can “push” station specific electronic content either visibly, so the user is aware of the transfer, or transparently, without the user's knowledge or input.

Further, the user can select what order and at what time the electronic content is provided and played back. For example, a user can select from stations like ESPN, Shock Jocks, Fox News, and easy listening audio content. Shock jock content can be aired live at any time, for example, The Howard Stern show is transmitted in the morning hours, but user can select that it is played back only after, for example, 8:00 p.m. when the user's children are asleep. Furthermore, user can select the ESPN content be played first between, for example, 8:00-10:00 a.m., easy listening between 10:00 a.m. to noon, Fox News from noon to 3:00 p.m. and then easy listing until 8:00 p.m.

The user can select electronic content to be “broken in” during a differently scheduled set of electronic content. For example, the user can select that any news item from Fox News involving Iraq be broken in at any time during the day when Fox News is not selected. The user can select keywords or key topics and every time electronic content is identified by the selected keyword or topic, the electronic content is broken into the existing selection. User can select from a break-in list of preselected electronic content identified by the provider system as either the only content allowed to be broken in or the top selections. Break-in content interrupts the scheduled electronic content, pauses the scheduled electronic content, plays break-in content, and then returns to the scheduled electronic content.

Another option is to filter and accumulate, either on one station or across multiple stations specifically selected electronic content. User can select a break-in parameter by keyword or is provided a break-in list, as described above, and all electronic content matching that keyword to be selected and stored for playback at a chosen time.

Once a schedule of the selected electronic content is prepared, the user can select the playback device the scheduled electronic content can be played back on. For example, user can select car A/V and stereo and the scheduled content is streamed/downloaded to both playback devices. The provider system can include warnings that certain content can be used or limited by the selected playback device. Further, the provider system can analyze the selection and suggest electronic content that is the proper file for the device selected. Alternately, the user can select that only certain stations are transmitted to certain devices within the same schedule. In embodiments, numerous schedules can be created and timed for different periods.

The playback devices are configured (by either hardware or software protocols) to communicate with the provider system every time the playback devices are linked to the network. The provider system checks the electronic content stored on the playback device and refreshes it as necessary. Further, the provider system can track which playback device is in use at a given time and provide “handoff” features between playback devices. The user can begin a playback session at home using stereo, once stereo is turned off, provider system attempts to detect the next playback device activated by user. The user enters his car and activates the car A/V system. The provider system detects the activation of car A/V system and handoffs the electronic content that user was just playing back on stereo. The provider system restarts the playback exactly where the user left off when user turned off/stopped playback on stereo. The program can be further handed off to cell phone when user exits his car and travels on foot to his destination. Once user is at his destination, for example his place of work, MP3 player or computer can receive the handed off electronic content and user can have a seamless playback experience. This feature allows a user to listen to the same content on multiple devices without having to constantly make sure the content is downloaded to the specific playback device and searching on each device where the stopping point was on the previous device.

Additionally, provider system can allow user to identify temporary playback devices which are not the user's device but belong to a different party or user and the user is borrowing the temporary playback device for some specific length of time. The user identifies the temporary playback device and user's content is delivered to the temporary playback device. For security and electronic content protection, electronic content sent to temporary playback device can be deleted once the temporary playback device is powered down or once user's normal playback device is activated. The handoff procedure can also be used when user travels and the playback devices at the hotel can be designated temporary playback devices. With this system, the user can have access to his preferred content wherever the user is located.

Another embodiment of the present invention automatically generates playlists or schedules based on the user's previous selections. The provider system can use forms of programming algorithms or “artificial intelligence” as an analysis device to scan the electronic content selected by the user and either automatically add or suggest new electronic content not previously selected by the user.

Analysis device can further analyze the selected electronic content and select new electronic content e.g. provide a new song after analyzing the current song playlist. The analysis device can use parameters either programmed in or selected by the user. Exemplary parameters can be, any electronic content by the same artist, actor, director, composer, or writer not already selected, both old and new and electronic content in the same genre but by different parties.

Further, analysis device can analyze reviews of the electronic content of the artist, actor, director, composer, or writer, search for exemplarily similarities and suggest new electronic content based on the similarities. Alternately, or in addition to, the analysis device can analyze the amount of unused memory on the user device and generate a playlist or schedule to fill any or all available memory on the user device. The schedule generated by the analysis device can, in an embodiment, follow the same rendering pattern as a user selected schedule and just insert new electronic content.

In a further embodiment, the analysis device can present user with a list of generic and specific questions or choices and create playlists and schedules using the answers. The user does not need to have already selected any electronic content for the analysis device to automatically create playlists and schedules. The questions can be somewhat generic, for example, “What time to you wake up?,” “Do you drive to work?,” and “What time do you go to the gym?” Using the answers, analysis device can schedule weather and easy listening for the user to wake up to, talk radio with traffic break-in content for the drive to work and up-tempo motivational music when user is at the gym. The analysis device can also pre-select the correct user device as well.

Furthermore, if the user links a PDA or cell phone with the user's organizer, the analysis device can alter the user's schedule or customize the automatically generated schedule to the user's date book. For example, user schedules a particular station from noon to 1:00 p.m. because that is the time the user is at the gym. If the user updates his PDA to move his scheduled gym time, either for a day or permanently, to 1:00 p.m. to 2:00 p.m., analysis device automatically alters the schedule so the “gym” station is played back between 1:00 p.m. to 2:00 p.m. Analysis device can also perform the schedule shifting “on the fly”. The user can select certain electronic content to be played only on a certain device regardless of time. For example, every time user activates the car A/V, traffic reports are automatically played first, wherein the traffic reports are never played on the MP3 player.

A method for the real-time distribution of electronic content, includes receiving, from the user, a selection of electronic content and identifying a first user device for rendering the selected electronic content. The provider system communicates with the first user device and transmits the selected electronic content to the first user device. The selected electronic content on the first user device is automatically updated. The automatic updating of the electronic content on the user device can be continuous as long as the user device is networked or the electronic content can be updated only when there is an update to the selected electronic content. In an embodiment, the automatic updating can happen in real-time as the content is changing.

Receiving the selection can include selecting, by the user, a station having the electronic content and can also include selecting break-in content and interrupting a rendering of the selected electronic content with a rendering of the break-in content. Selecting the break-in content includes receiving, from a user, a break-in parameter and scanning the selected electronic content for the break-in parameter. The break-in parameter can be a user selected keyword or selected from break-in list or can be scanned for by scanning the entire piece of electronic content, or just a synopsis of the electronic content or “header” information transmitted with the electronic content. The user, in an embodiment, can be given a choice as to how the break-in parameter is searched for. The selected electronic content containing the break-in parameter is converted to break-in content. Once the content is converted, it is broken in the current rendering.

In another embodiment, a method of real-time distribution includes identifying a second user device and communicating with the second user device. The selected electronic content can be rendered on the first user device and when the first user device stops rendering the selected electronic content a position where the selected electronic content stopped can be determined. The selection of electronic content is transmitted to the second user device and automatically rendered starting at the determined position, on the second user device.

The electronic content can be transmitted to the second user device any time before or after the electronic content is transmitted to the first user device. If both the first and second user devices are powered and networked, the electronic content can be transmitted simultaneously to both devices. Alternately, the electronic content can be “pre-loaded” for the next period during the prior period.

Further embodiments of the method for the real-time distribution of electronic content include identifying a temporary user device and communicating with the temporary user device. The selected electronic content is transmitted to and rendered on the temporary user device. The selected electronic content can be removed from the temporary user device upon at least one of after the rendering step, identifying a rendering of the selected electronic content of the first user device or a predetermined time period after the rendering on the temporary user device.

Furthermore, an embodiment of the above methods can include analyzing the selection of electronic content and automatically transmitting new electronic content, similar to the selected electronic content, to the first user device. In a further embodiment, the receiving the selection step can include receiving, from the user, answers to one or more questions based on the electronic content, analyzing the answers and determining the selected electronic content based on the answers.

Another embodiment includes receiving, from the user, a schedule for the rendering of the selected electronic content and analyzing one or more entries in a date book of the user. The analysis device can match scheduled stations or electronic content against entries in the date book. Alternately, user can manually link electronic content, stations or schedules to entries or dates and times in the date book. The schedule can be altered based on the one or more entries.

An embodiment for a method for the real-time distribution of electronic content includes communicating with a first user device for rendering the electronic content and determining an amount of free memory on the first user device. Electronic content can be automatically transmitted to the first user device to fill less than or equal to the amount of free memory. The analysis device, in an embodiment, can calculate the memory required for the largest schedule and only automatically supply electronic content based on the amount of free memory remaining when largest schedule is loaded onto the user device.

In another embodiment, the method includes receiving, from a user, a selection of electronic content and analyzing the selection as described above. The new electronic content, similar to the selected electronic content, can be automatically transmitted to the first user device to fill less than or equal to the amount of free memory. Further, provider system can receive answers to one or more questions based on the electronic content and analyze the answers. Selected electronic content is determined based on the answers, for example a new playlist can be generated. The selected electronic content can be automatically transmitted to the first user device to fill less than or equal to the amount of free memory.

### BRIEF DESCRIPTION OF THE DRAWINGS

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a diagram illustrating a system of the present invention;

FIG. 2 illustrates an electronic content selection menu of the present invention;

FIG. 3 illustrate a scheduling menu of the present invention;

FIG. 4 illustrates a delivery and handoff system of the present invention;

FIG. 5 illustrates an analysis device of the present invention;

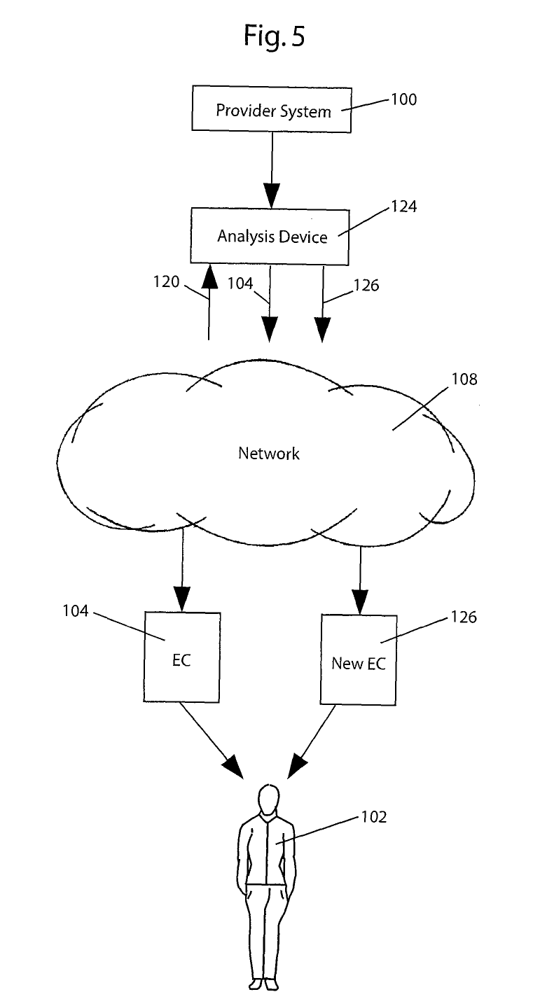

FIG. 6 is a flow chart illustrating a method of the present invention;

FIG. 7 is a flow chart illustrating an alternate embodiment of a method of the present invention;

FIGS. 8A-8C are flow charts illustrating further embodiments of methods of the present invention; and

FIG. 9 is a flow chart illustrating another embodiment of a method of the present invention.

### DETAILED DESCRIPTION OF THE PRESENT INVENTION

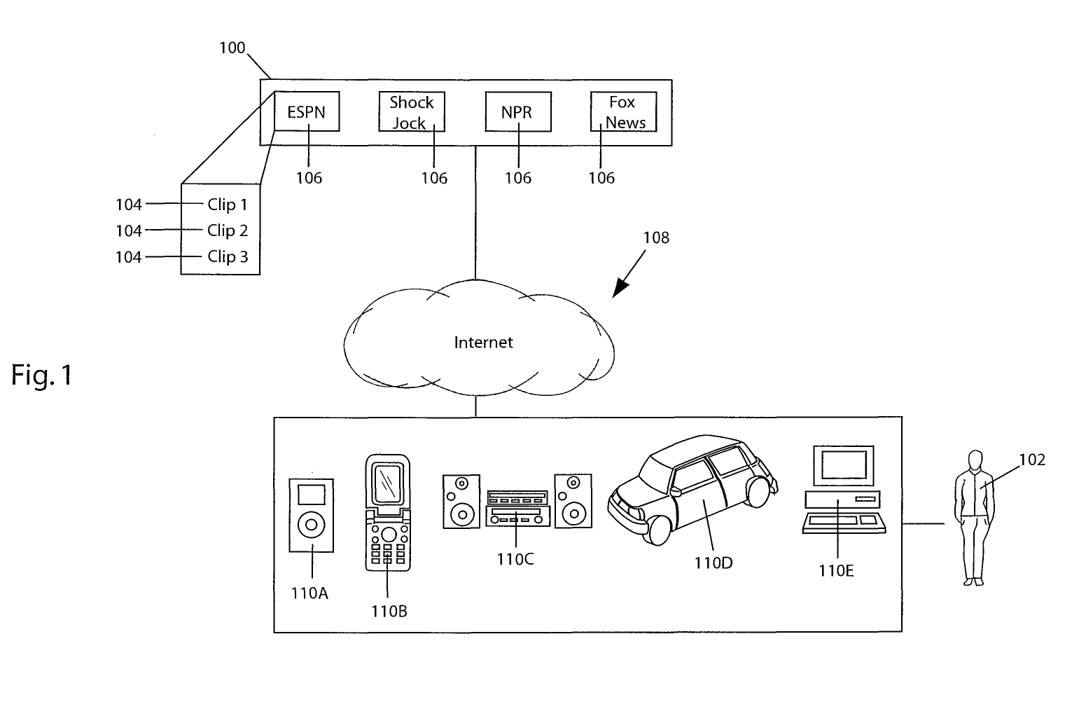

The present invention allows a user to have pre-selected content refreshed automatically every time the playback device is connected to the provider. FIG. 1 illustrates an embodiment of the invention. A provider system 100 makes available to a user 102 multiple types of electronic content 104. Provider system 100 can include a server or a group of servers as known in the art. Electronic content 104 can be stored on the same server as the provider system 100 or can be stored remotely and accessed as requests from user 102 are processed. A provider front end and distribution system are known in the art. Electronic content 104, as above, can be audio, video, still images, data, software, text or a combination of any or all types. Electronic content 104 can be divided into categories or stations 106 based on a common theme. Some generic examples are “easy listening” audio content, western video content, sports, or audio or video from a particular radio disk jockey, news reporter, movie director, artist, or actor.

User 102 typically connects to the provider system 100 over a network 108 which can be a wired or wireless LAN (local area network), WAN (wide area network), cellular/telephone network or the Internet. User 102 also has one or more devices 110 to playback the electronic content 104A. Devices 110 can be an MP3 player 110A, a cellular telephone/pager/Blackberry 110B, a stereo/DVR 110C, a car mounted audio/video system 110D and at least a computer/laptop/PDA 110E.

User 102 accesses an account with provider system 100 and provides the required information to the provider system 100 regarding his playback devices 110. User 102 then selects one or more stations 106 of electronic content 104. Once the user 102 has selected station 106 and/or electronic content 104, user 102 can be prompted as to which playback device 110 should be linked to each station 106. For example, user 102 may prefer a station 106 with audio only electronic content 104 to be provided to only MP3 player 110A and cell phone 110B and video electronic content 104 to DVR 110C. Once the stations 106 and playback devices 110 are configured, provider system 100 continuously updates playback devices 110 every time playback devices 110 are networked to the provider system 100. Provider system 100 can “push” station 106 specific electronic content 104 either visibly, so the user 102 is aware of the transfer, or transparently, without the user's knowledge or input.

Further, user 102 can select what order and at what time the electronic content 104 is provided and played back. For example, a user can select from stations 106 like ESPN, Shock Jocks, Fox News, and easy listening audio content. Shock jock content can be aired live at any time, for example, The Howard Stern show is transmitted in the morning hours, but user 102 can select that it is played back only after, for example, 8:00 p.m. when the user's children are asleep. Furthermore, user 102 can select the ESPN content be played first between, for example, 8:00-10:00 a.m., easy listening between 10:00 a.m. to noon, Fox News from noon to 3:00 p.m. and then easy listing until 8:00 p.m.

User 102 can select electronic content 104 to be “broken in” during a differently scheduled set of electronic content 104. For example, user 102 can select that any news item from Fox News involving Iraq be broken in at any time during the day when Fox News is not selected.

All electronic content is unavailable or restricted before its “air time”. For example, The Howard Stern Show is broadcast live and can only be available contemporaneously with the initial broadcast or after the broadcast is completed. Other content, for example some content on ESPN, maybe taped before its “air time” and access to the content can be restricted until the air time of the content. However, a provider system 100 can allow user 102 access to the content after taping but before its air time, either as a regular service, upgraded service or special feature.

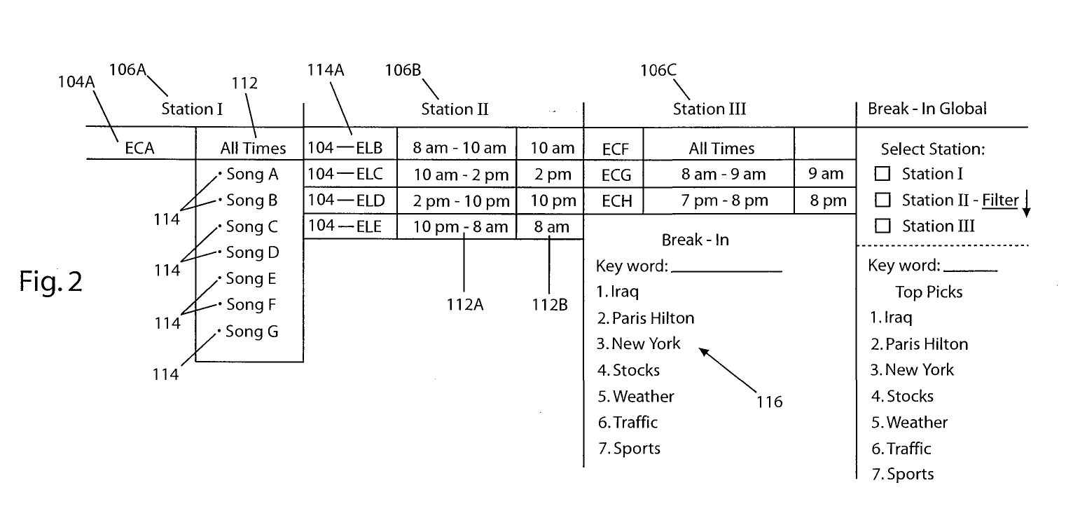

FIG. 2 illustrates an exemplary menu of choices for user 102 to select content 104 and stations 106. Each station 106 can have a title and a list of electronic content 104 along with a listing of times 112 the electronic content is available. Listing 112 can include the contemporaneous broadcast times 112A and the earliest time 112B electronic content 104 is available for complete download and playback. Station I 106A can be, for example, the easy listening station. Electronic content “A” 104A is available at “all times” and user can select this content to be played continuously at any time. “All times” means the content is similar to a radio station and user 102 can tune in whenever and the electronic content 104 is broadcast.

User 102 can select electronic content A 104A and see subcontent 114. Subcontent 114 is the electronic content 104 that is collected for that station 106. For station 106A, subcontent 114 can be a list of all the songs that are performed for station 106A. User 102 can select the order in which subcontent 114 is played back and whether to remove some subcontent 114 (e.g. songs) from the list. Thus, the user can personalize the station and subcontent with a playlist 115, a list of subcontent 114 user 102 want to listen to in the order user 102 want to listen to it.

Station II 106B can be the “Shock Jock” station where different “shock jock” electronic content 104 can be selected. Station II 106B can be selected as a whole or the subcontent 114 can be selected. For example, Howard Stern can be subcontent 114A. Listing 112 for Howard Stern shows that it is played contemporaneously between 6:00 a.m. and 10:00 a.m., Eastern Time and is available for full download and selected listening after 10:00 a.m. Eastern Time.

Station III 106C can be a news channel. User 102 can select the “all times” version and user 102 receives the contemporaneous news at the time selected. News programs can contain subcontent 114 and the particular subcontent 114 can be selected as above. Subcontent 114 can be a particular news reporter or news show. Additionally, user 102 can indicate that this content can be “broken in”. User 102 can select keywords or key topics and every time electronic content 104 is identified by the selected keyword or topic, the electronic content 104 is broken into the existing selection. User 102 can select from a break-in list 116 of preselected electronic content 104 identified by the provider system 100 as either the only content allowed to be broken in or the top selections. For example, electronic content 104 based on the stock market, weather, sports, or traffic can be selected. Alternately, user 102 can be provided an input line to input a keyword, for example “Iraq”. Any electronic content 104 on Station III 106C that contains or is identified with the selected keyword, is then forwarded to user 102 as break-in content 118. Break-in content 118 interrupts the scheduled electronic content 104, pauses the scheduled electronic content 104, plays break-in content 118, and then returns to the scheduled electronic content 104. Thus, user 102 can listen to a selected electronic content and only be interrupted for specified break-in content 118. User 102 no longer has to listen to an entire broadcast to hear the one or two items the user is interested in.

Another option is to filter and accumulate, either on one station 106 or across multiple stations 106 specifically selected electronic content 104. User 102 can select a break-in parameter by keyword or is provided a break-in list 116, as described above, and all electronic content 104 matching that keyword to be selected and stored for playback at a chosen time. Thus, user 102 can select Station III 106C and “Iraq” and all of the news stories related to Iraq are filtered out and prepared for playback at, for example, 8:00 p.m. Also, multiple stations can be selected, for example, Station II 106B and Station III 106C. So the electronic content 104 from both the news station and the shock jock station related to Iraq can be accumulated and played back to user 102. Furthermore, user 102 can select the specific subcontent 114 the filter applies to, allowing only Howard Stern's comments on Iraq to be filtered and sent and not from any of the other shock jocks provided on Station II.

Additional listings for each electronic content 104, station 106, and subcontent 114 can be a description for the type of content (e.g. audio, still image, video and/or a combination of all the above) of the content, a rating for content (e.g. G, PG, R, etc.) and a rating for quality of the content (e.g. 1 to 5 stars).

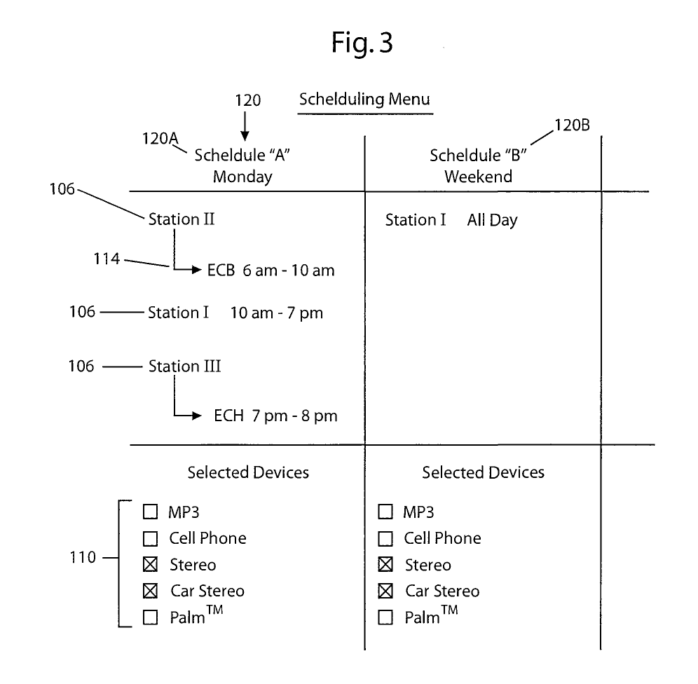

FIG. 3 illustrates a scheduling menu. Once a schedule 120 of the selected electronic content 104 is prepared, the user can select playback device 110 the scheduled electronic content 104 can be played back on. For example, user 102 can select car A/V 110D and stereo 110C and the scheduled 120 content is streamed/downloaded to both playback devices. Provider system 100 can include warnings that certain content can be used or limited by the selected playback device 110. For example, if user 102 selects electronic content 104 that is a video file, user 102 is warned that stereo 110C cannot playback the video and either select different content and/or playback device or that stereo 110C only plays back the audio portion of the video content and the visual portion is not displayed. Further, provider system 100 can analyze the selection and suggest electronic content 104 that is the specific audio embodiment of the video file selected. For example, if user 102 selects a video file of a baseball game, when the file is to be preformed on stereo 110C, provider system 100 automatically transmits the audio version of the same baseball game with the “radio calls” so user 102 can understand the game. Alternately, the user can select that only certain stations 106 are transmitted to certain devices 110 within the same schedule.

In embodiments, numerous schedules 120A, 120B can be created and timed for different periods. For example, Schedule A 120A can be preset for Mondays and Schedule B 120B for weekends. Provider system 100 can automatically switch between schedules 120A, 120B and once user 102 makes his selections, electronic content 104 is constantly provided according to the schedule 120.

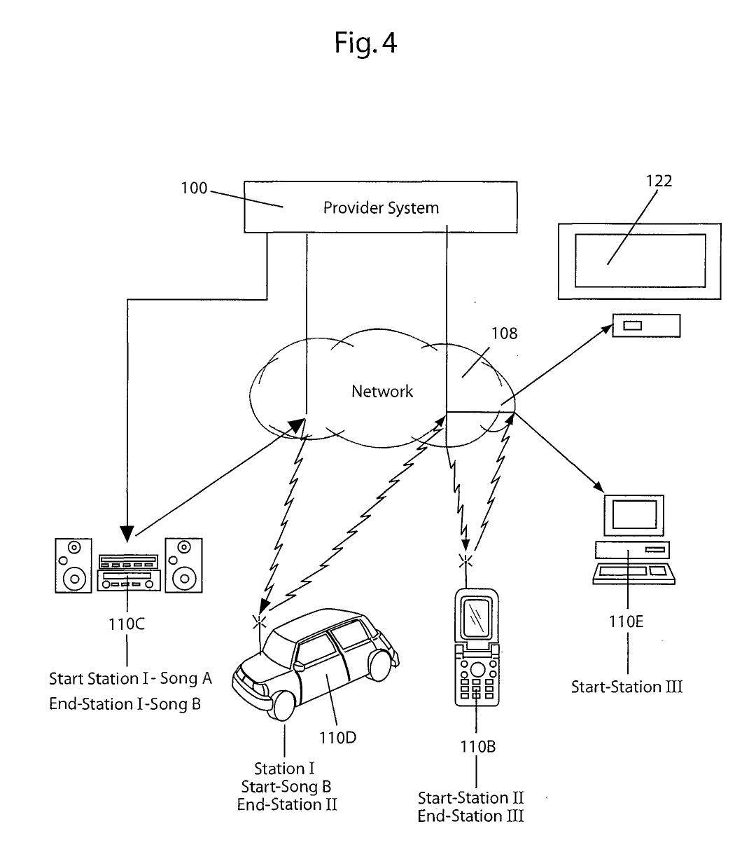

FIG. 4 illustrates the delivery system to deliver the scheduled content 104 to user 102. Provider system 100, as stated above, has a list of all of the user's 102 playback devices 110. Playback devices 110 are configured (by either hardware or software protocols) to communicate with the provider system 100 every time the playback devices 110 are linked to the network 108. Provider system 100 checks the electronic content stored on the playback device 110 and refreshes it as necessary. For example, if user 102 selected break-in content 118, that content is downloaded (or pushed) to MP3 player 110A the next time MP3 player 110A is networked. Additionally, if user 102 selected the content to be transferred to cell phone 110B, cell phones 110B are typically always connected to the cell phone network and the break-in content 118 is transferred as soon as it is available. User 102 can already be in the middle of a playback session and the break-in content 118 interrupts the scheduled playback. Alternately, user 102 may not be in a playback session and user 102 can be notified (by, for example, a pager tone or special ring tone) that break-in content 118 is available for playback. User 102 can be notified by any of the playback devices 110 and the feature is not limited to cell phones 110B.

Further, provider system 100 can track which playback device 110 is in use at a given time and provide “handoff” features between playback devices. User 102 can begin a playback session at home using stereo 110C, once stereo 110C is turned off, provider system 100 attempts to detect the next playback device activated by user 102. User 102 enters his car and activates the car A/V system 110D. Provider system 100 detects the activation of car A/V system 110D and handoffs the electronic content 104 that user 102 was just playing back on stereo 110C. Provider system 100 restarts the playback exactly where user 102 left off when user 102 turned off/stopped playback on stereo 110C. The program can be further handed off to cell phone 110B when user 102 exits his car and travels on foot to his destination. Once user 102 is at his destination, for example his place of work, MP3 player 110A or computer 110E can receive the handed off electronic content 104 and user 102 can have a seamless playback experience. This feature allows a user to listen to the same content on multiple devices without having to constantly make sure the content is downloaded to the specific playback device 110 and searching on each device where the stopping point was on the previous device.

Additionally, provider system 100 can allow user 102 to identify temporary playback devices 122. Temporary playback devices 122 are not user's 102 devices but belong to a different party or user and user 102 is borrowing the temporary playback device 122 for some specific length of time. User 102 identifies the temporary playback device 122 and user's content is delivered to temporary playback device 122. For security and electronic content protection, electronic content 104 sent to temporary playback device 122 can be deleted once the temporary playback device 122 is powered down or once user's 102 normal playback device 110 is activated. For example, user's 102 children can be watching video electronic content on home video playback device 110C, this electronic content can be transferred to car A/V system 110D and is then handed off to temporary playback device 122, a video playback device at a friend's or grandparent's house. Provider system 100 can store a list of user 102 frequent temporary playback devices 122 or, they can be configured each time user 102 uses one. The handoff procedure can also be used when user 102 travels and the playback devices at the hotel can be designated temporary playback devices 122. With this system, user 102 is assured access to his preferred content wherever user 102 is located.

Another embodiment of the present invention is automatically generating playlists 115 or schedules 120 based on the user's 102 previous selections. Provider system 100 can use forms of programming algorithms or “artificial intelligence” as an analysis device 124 to scan the electronic content 104 selected by user 102 and either automatically add or suggest new electronic content 126 not previously selected by user 102. For example, analysis device 124 can review a user's selected stations 106 and suggest a new station 106. Analysis device 126 can further analysis the selected electronic content 104 and select new electronic content 126 e.g. provide a new song after analyzing the current song playlist 115. The analysis device 126 can use parameters either programmed in or selected by the user 102. Exemplary parameters can be, any electronic content 104 by the same artist, actor, director, composer, or writer not already selected, both old and new and electronic content in the same genre but by different parties.

Further, analysis device 124 can analyze reviews of the electronic content 104 of the artist, actor, director, composer, or writer, search for exemplarily similarities and suggest new electronic content 126 based on the similarities. For example, user has previously selected a number of Alfred Hitchcock films and analysis device 126 may suggest new electronic content 126 from a director who makes movies in the “Hitchcock Style.” Suggestions for a new artist who sounds like “James Taylor” can be presented after analyzing user's content and determining a large percentage of James Taylor electronic content 104.

Alternately, or in addition to, analysis device 124 can analyze the amount of unused memory on user device 110 and generate a playlist or schedule 120 to fill all available memory on the user device 110. For example, MP3 player 110A has 1 GB of memory and analysis device 124 can deliver 1 GB of electronic content 104 to fill the memory. Also, if user 102 has, for example, already selected 500 MB of electronic content 104, analysis device 124 can fill the remaining 500 MB with new electronic content 126. The schedule 120 generated by the analysis device 124 can, in an embodiment, follow the same rendering pattern as a user selected schedule 120 and just insert new electronic content 126. For example, a user can select ESPN content be played first between 8:00-10:00 a.m., easy listening between 10:00 a.m. to noon, Fox News from noon to 3:00 p.m., easy listing until 8:00 p.m. and Howard Stern from 8:00 p.m. until midnight. Analysis device 124 can create a new schedule of sports talk radio (e.g. “Mike and the Mad Dog”) from 8:00-10:00 a.m., easy listening (with new artists and/or songs) between 10:00 a.m. to noon, CNN from noon to 3:00 p.m., easy listing until 8:00 p.m. and Opie and Anthony from 8:00 p.m. until midnight.

In a further embodiment, analysis device 124 can present user 102 with a list of generic and specific questions or choices and create playlists 115 and schedules 120 using the answers. User 102 does not need to have already selected any electronic content 104 for analysis device 124 to automatically create playlists 115 and schedules 120. The questions can be somewhat generic, for example, “What time to you wake up?,” “Do you drive to work?,” and “What time do you go to the gym?” Using the answers, analysis device 124 can schedule weather and easy listening for the user to wake up to, talk radio with traffic break-in content for the drive to work and up-tempo motivational music when user 102 is at the gym. Analysis device 124 can also pre-select the correct user device 110 as well. Thus, the weather and music is transmitted to stereo 110C, the traffic and talk-radio to car A/V 110 and the motivational music to MP3 player 110A. More detailed questions asking a user to select favorite genres and artists or generate a list of most selected genres and artists.

Furthermore, if user 102 links a PDA 110E or cell phone 110B with the user's organizer, analysis device 124 can alter the user's schedule 120 or customize the automatically generated schedule 120 to the user's date book. For example, user 102 schedules a particular station 106 from noon to 1:00 p.m. because that is the time the user is at the gym. If user 102 updates his PDA 110E to move his scheduled gym time, either for a day or permanently, to 1:00 p.m. to 2:00 p.m., analysis device 124 can automatically alter the schedule 120 so the “gym” station 106 is played back between 1:00 p.m. to 2:00 p.m. Analysis device 124 can also perform the schedule shifting “on the fly”. User 102 can select certain electronic content 104 to be played only on certain device 110 regardless of time. For example, every time user 102 activates car A/V 110D, traffic reports are automatically played first, wherein the traffic reports are never played on MP3 player 110A.

The present invention can utilize a “master token” DRM system to pass electronic content 104 between playback devices 110. A master token DRM solves the problem of security between the numerous playback and temporary playback device 110, 122 and this system is know to those of ordinary skill in the art to allow playback devices to communicate with each other.

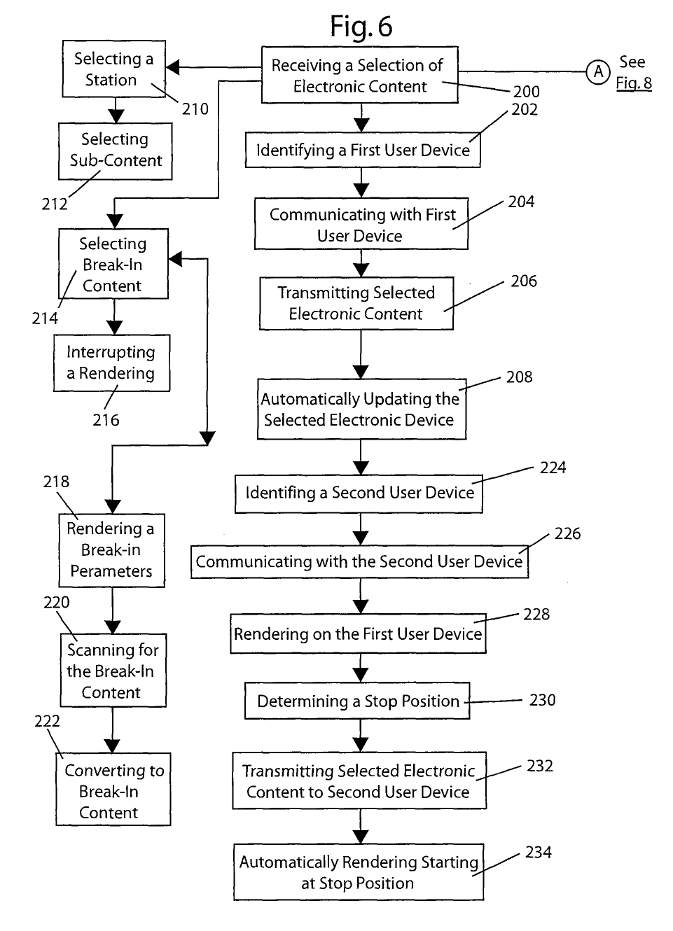

A method of the present invention is illustrated in FIG. 6. A method for the real-time distribution of electronic content, includes receiving, from user 102, a selection of electronic content 104 (step 200) and identifying a first user device 110 for rendering the selected electronic content 104 (step 202). Provider system 100 communicates with the first user device 110 (step 204) and transmits the selected electronic content 104 to the first user device 110 (step 206). The selected electronic content 104 on the first user device 110 is automatically updated (step 208). The automatic updating of the electronic content 104 on the user device 110 can be continuous as long as the user device 110 is networked—for example, the electronic content 104 is streamed, or the electronic content 104 can be updated only when there is an update to the selected electronic content. In an embodiment, the automatic updating can happen in real-time as the content is changing.

Receiving the selection can include selecting, by the user 102, station 106 having electronic content 104 (step 210). User 102 can also select subcontent 114 on the station 106 (step 212). Receiving the selection can also include selecting break-in content 118 (step 214) and interrupting a rendering of the selected electronic content 104 with a rendering of the break-in content 118 (step 216). Selecting the break-in content 118 includes receiving, from a user 102, a break-in parameter (step 218) and scanning the selected electronic content 104 for the break-in parameter (step 220). The break-in parameter can be a user 102 selected keyword or selected from break-in list 116. Provider system 100 can search for the break-in parameter by scanning the entire piece of electronic content 104 or just scanning a synopsis of the electronic content or “header” information transmitted with the electronic content 104. The user, in an embodiment, can be given a choice as to how the break-in parameter is searched for. If only the synopsis or “header” is scanned, generally, a majority of the electronic content 104 is about the topic selected as the break-in parameter. However, the user 102 may miss some commentary regarding the subject of the break-in parameter if the synopsis or header is too general or the topic changes during the rendering of the electronic content 104. Scanning the entire electronic content 104 can provide numerous other electronic content 104 files with the break-in parameter, but it could be a passing comment and not the focus of the electronic content 104. The selected electronic content 104 containing the break-in parameter is converted to break-in content (step 222). Once the content is converted, it is broken in the current rendering.

In another embodiment, a method of real-time distribution includes identifying a second user device 110 (step 224) and communicating with the second user device 110 (step 226). The selected electronic content 104 can be rendered on the first user device 110 (step 228) and when the first user device 110 stops rendering the selected electronic content 110 a position where the selected electronic content 104 stopped can be determined (step 230). The selection of electronic content 104 is transmitted to the second user device 110 (step 232) and automatically rendered starting at the determined position, on the second user device 110 (step 234).

The electronic content 104 can be transmitted to the second user device 110 any time before or after the electronic content is transmitted to the first user device 110. If both the first and second user devices 110 are powered and networked, the electronic content 104 can be transmitted simultaneously to both devices. Alternately, the electronic content 104 can be “pre-loaded” for the next period during the prior period. If the size of a memory on the user device 110 is large enough, long periods of electronic content 104 can be transmitted to either the first or second user device 110 and then only the portions that have changed are updated. The pre-loading can be performed if the provider system 100 detects that the user device 110 is on the verge of being disconnected from the network 108. For example, cell phone 110B can travel to locations of decreased or no service and provider system 100 can monitor signal strength and/or cell tower handoff to determine if user 102 may soon be out of range and pre-load some or all selected electronic content 104 to carry over the “blackout” of service until the next time the cell phone 110B is in range. Alternately, the user 102 can identify known blackout periods (e.g. during the user's commute using subways) and the provider system 100 can take that timing into account in how much and how often it updates the cell phone 110B. Alternate embodiments transmit the electronic content 104 “just-in-time” for them to be rendered. For example, a live broadcast ending at 10:00 am can be selected by the user 102 to be rendered at, for example, 10:05 am, the electronic content 104 can be transmitted all at once after the broadcast ends, so the user receives it just-in-time time to be rendered. Alternately, portions of the live broadcast can be transmitted in segments as natural breaks occur in the flow of the broadcast (e.g. commercial interruptions).

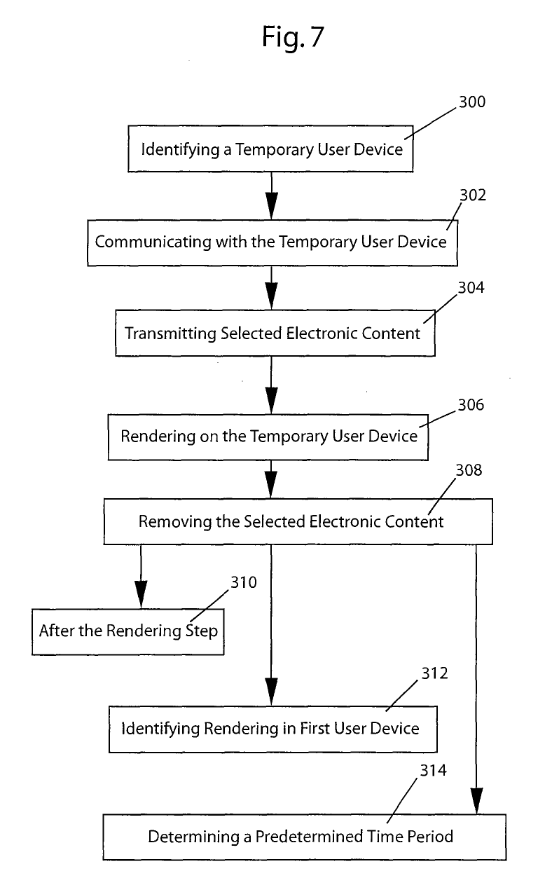

FIG. 7 illustrates further embodiments of the method for the real-time distribution of electronic content including identifying a temporary user device 122 (step 300) and communicating with the temporary user device 122 (step 302). The selected electronic content 104 is transmitted to the temporary user device 122 (step 304) and rendered on the temporary user device (step 306). Removing the selected electronic content from the temporary user device (step 308) upon at least one of after the rendering step (step 310), identifying a rendering of the selected electronic content 104 of the first user device (step 312) or a predetermined time period after the rendering on the temporary user device (step 314).

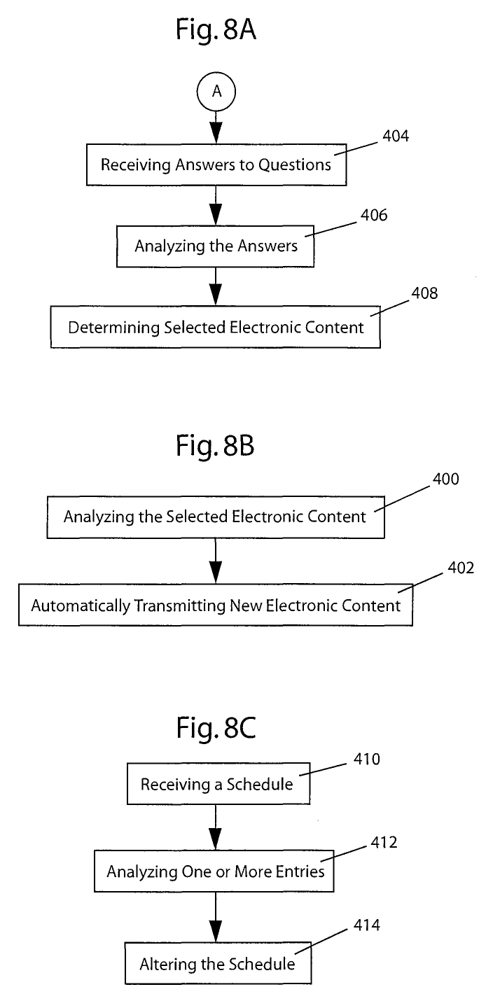

Referring now to FIGS. 8A, 8B and 8C, an embodiment of the above methods can include analyzing the selection of electronic content (step 400) and automatically transmitting new electronic content 126, similar to the selected electronic content 104, to the first user device 110 (step 402). In a further embodiment, the receiving the selection step (step 100) can include receiving, from the user, answers to one or more questions based on the electronic content (step 404), analyzing the answers (step 406) and determining the selected electronic content based on the answers (step 408).

Another embodiment includes receiving, from the user, a schedule for the rendering of the selected electronic content (step 410) and analyzing one or more entries in a date book of the user (step 412). Here, the user 102 selects a schedule 120 of electronic content 104 and that schedule can be linked to the user's date book/PDA/organizer. Analysis device 124 can match scheduled stations 106 or electronic content 104 against entries in the date book. Alternately, user 102 can manually link electronic content 104, stations 106 or schedules 120 to entries or dates and times in the date book. The schedule 120 can be altered based on the one or more entries (step 414).

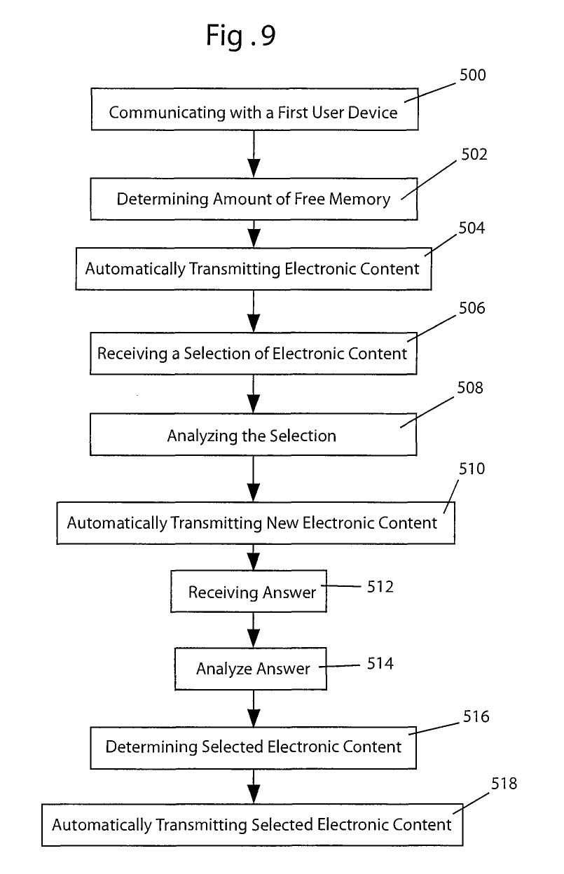

FIG. 9 illustrates an embodiment for a method for the real-time distribution of electronic content including communicating with a first user device 110 for rendering the electronic content 104 (step 500) and determining an amount of free memory on the first user device 110 (step 502). Electronic content 104 can be automatically transmitted to the first user device to fill less than or equal to the amount of free memory (step 504). Analysis device 124 may not fill the entire free memory because of subscription limits, lack of matching content or leaving sufficient memory for yet to be transmitted selected content that can take up more memory than the current electronic content. Analysis device 124, in an embodiment, can calculate the memory required for the largest schedule 120 and only automatically supply electronic content based on the amount of free memory remaining when largest schedule 120 is loaded on user device 110.

In another embodiment, the method includes receiving, from a user, a selection of electronic content (step 506) and analyzing the selection (step 508). New electronic content 126, similar to the selected electronic content 104, can be automatically transmitted to the first user device to fill less than or equal to the amount of free memory (step 510). Further, provider system 100 can receive from the user, answers to one or more questions based on the electronic content (step 512) and analyze the answers (step 514). Selected electronic content 104 is determined based on the answers (step 516), for example a new playlist 115 can be generated. The selected electronic content 104 can be automatically transmitted to the first user device 110 to fill less than or equal to the amount of free memory (step 518).

While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

We claim:

1. A method for the real-time distribution of electronic content, comprising the steps of:
receiving, from a user, a selection of electronic content;
identifying a first user device for rendering the selected electronic content;
communicating with the first user device;
transmitting the selected electronic content to the first user device; and
automatically updating the selected electronic content on the first user device.

2. The method of claim 1, wherein the receiving the selection step comprises the step of selecting, by the user, a station having electronic content.

3. The method of claim 2, wherein the receiving the selection step further comprises the step of selecting, by the user, subcontent on the station.

4. The method of claim 1, wherein the receiving the selection step comprises the steps of:
selecting break-in content; and
interrupting a rendering of the selected electronic content with a rendering of the break-in content.

5. The method of claim 4, wherein the selecting the break-in content step comprises the steps of:
receiving, from a user, a break-in parameter;
scanning the selected electronic content for the break-in parameter; and
converting the selected electronic content containing the break-in parameter to break-in content.

6. The method of claim 1, further comprising the steps of:
identifying a second user device;
communicating with the second user device;
rendering the selected electronic content on the first user device;
determining a position where the first user device stopped the rendering of the selected electronic content;
transmitting the selection of electronic content to the second user device; and
automatically rendering the selected electronic content, starting at the determined position, on the second user device.

7. The method of claim 1, further comprising the step of:
identifying a temporary user device;
communicating with the temporary user device;
transmitting the selected electronic content to the temporary user device;
rendering the selected electronic content on the temporary user device; and
removing the selected electronic content from the temporary user device, upon at least one of:
after the rendering step;
identifying a rendering of the selected electronic content of the first user device; and
determining a predetermined time period after the rendering on the temporary user device.

8. The method of claim 1, further comprising the steps of:
analyzing the selection of electronic content; and
automatically transmitting new electronic content, similar to the selected electronic content, to the first user device.

9. The method of claim 1, wherein the receiving the selection step comprises the steps of:
receiving, from the user, answers to one or more questions based on the electronic content;
analyzing the answers; and
determining the selected electronic content based on the answers.

10. The method of claim 1, further comprising the steps of:
receiving, from the user, a schedule for the rendering of the selected electronic content;
analyzing one or more entries in a date book of the user; and
altering the schedule based on the one or more entries.

11. A method for the real-time distribution of electronic content, comprising the steps of:
communicating with a first user device for rendering the electronic content;
determining an amount of free memory on the first user device; and
automatically transmitting the electronic content to the first user device to fill less than or equal to the amount of free memory.

12. The method of claim 11, further comprising the steps of:
receiving, from a user, a selection of electronic content;
analyzing the selection of electronic content; and
automatically transmitting new electronic content, similar to the selected electronic content, to the first user device to fill less than or equal to the amount of free memory.

13. The method of claim 11, further comprising the steps of:
receiving, from the user, answers to one or more questions based on the electronic content;
analyzing the answers;
determining selected electronic content based on the answers; and
automatically transmitting the selected electronic content, to the first user device to fill less than or equal to the amount of free memory.
